(19) United States
(12) Patent Application Publication
(10) Pub. No.: US 2007/0140207 A1
(43) Pub. Date: Jun. 21, 2007

(54) Communication system, communication apparatus, communication method and base station

(75) Inventor: Koji Narushima, Kanagawa (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION

(21) Appl. No.: 11/445,496

(22) Filed: May 31, 2006

(30) Foreign Application Priority Data
May 31, 2005 (JP) P.2005-158961
May 31, 2005 (JP) P.2005-160731

(51) Int. Cl. H04J 3/00

(52) U.S. Cl. 370/345; 370/498

(57) ABSTRACT

A communication method includes receiving broadcasting of a content intermittently by first communication system, and monitoring second communication system periodically by performing switching from the first communication system. In the first communication system, content is transmitted by being divided into packets, and transmission timings of the packets are shifted. Furthermore, timing for transmission of page message from 1x base station to each terminal is limited to a specific period during one slot cycle. EV-DO base station transmits BCMCS data during a period that does not overlap the specific period. When the page message reception timing is reached while the apparatus is receiving BCMCS data, the system is switched from EV-DO to 1x, and the reception of messages is started during the period. Thereafter, the communication system is returned to lx, and the reception of BCMCS data is resumed.

This application claims foreign priorities based on Japanese Patent application No. 2005-158961, filed May 31, 2005, and Japanese Patent application No. 2005-160731, filed May 31, 2005, the contents of which are incorporated herein by reference in its entirety.

### BACKGROUND OF THE INVENTION

1. Field of the Invention

The present invention relates to a hybrid mobile communication apparatus, which supports 1x system and 1xEV-DO system that can shift a transmission timing of BCMCS (Broadcast Multicast Service) data during a predetermined cycle by a predetermined interval, a communication system therefor, and a base station thereof.

The present invention also relates to a communication apparatus that can communicate with a base station by switching between different communication systems such as cdma2000 1x system and the 1xEV-DO system, and that can receive broadcast data for which a retransmission process is not performed even when a transfer error has occurred, and also relates to a communication method therefor.

2. Description of the Related Art

Multifunctioning for mobile phones has been developed, and fast data communication has become available in addition to voice communication. For example, a hybrid mobile communication system is known in which fast data communication can be performed not only by a communication system called cdma2000 1x (hereinafter referred to as “1x”), which is used mainly for voice communication, but also by a communication system called cdma2000 1xEV-DO, (hereinafter referred to as “EV-DO”) in which a downlink (from a base station to a mobile phone) data transfer rate has been improved.

A terminal that supports the hybrid communication system generally can employ a single antenna by switching between the two communication systems. That is, circuits (hereinafter referred to as “RF circuits”) for performing processes such as amplification, modulation and demodulation of RF (radio frequency) signals, are respectively provided for the 1x and for the EV-DO, and a switching circuit is inserted between the two RF circuits and the single antenna. When one of the RF circuits is connected to the antenna, the other RF circuit is disconnected from the antenna, so that communication can not be performed simultaneously by the two communication systems.

During the communication performed using one of the communication systems, 1x or EV-DO, the terminal performs communication with the base station of the other communication system for every 5.12 seconds, so that a signal can be received via the other communication system. For example, when data communication is being performed using the EV-DO, for every 5.12 seconds the antenna is switched from the RF circuit for the EV-DO to the RF circuit for the 1x, and a message (a page message) is received that has been transmitted by the 1x base station via a communication channel called a page channel. Further, when voice communication using the 1x is being performed, for every 5-12 seconds the antenna is switched from the RF circuit for the 1x to the RF circuit for the EV-DO, and a message (an overhead message) is received that has been transmitted by the EV-DO base station via a communication channel called a control channel.

As described above, in a mobile communication system that can transmit and receive BCMCS data, a terminal that supports the 1xEV-DO hybrid system switches the RF circuit to perform 1x voice/data communication and the 1xEV-DO communication.

Further, the terminal switches the RF circuit to either system for every 5.12 seconds, so as to receive voice/data from either system. When the 1x system is connected, the page channel is searched to receive the page message, or when the EV-DO system is connected, the control channel is searched to receive the overhead message.

A value which represents the interval of 5.12 seconds by a slot unit (80 ms) is called a slot cycle.

The timing to switch from the EV-DO to the 1x is determined in accordance with a numerical value called “PGSLOT”, which is calculated based on an IMSI (International Mobile subscriber Identity), a number used to identify a terminal, when operation of the terminal is initiated.

The 1x base station divides a period starting from the time when the system is activated by every 5.12 seconds so as to obtain specific timed intervals, and transmits the page message at a point having an offset equal to PGSLOT (unit=80 ms) from a starting point of each interval (one slot cycle). At this point, a terminal under communication via the 1x monitors the page channel for one slot (80 ms), and receives the page message addressed to the terminal. On the other hand, a terminal under communication via the EV-DO must also receive the page message such as the one described above that is transmitted from the 1x base station, for each slot cycle.

FIG. 14 is a diagram showing a state wherein the 1x base station transmits a message via the page channel periodically, for every 5.12 seconds.

The timing for receiving the page message from the 1x base station is obtained using the following calculation expression.
(└t/4−PGSLOT┘)mod(16×T)=0 (Ex. (1)]

In expression (1), It” denotes a CDMA system time (a period starting from the time when the system was activated), and

“T” denotes integer “4”.

PGSLOT in expression (1) is obtained using the following calculation expression.
PGSLOT=└N×((40503×(L⊕H⊕DECORR)mod 2¹⁶))/2¹⁶┘ [Ex. (2))

The individual variables in expression (2) are represented as follows.
N=2048
L=HASH_KEY[0 . . . 15]
H=HASH_KEY[16 . . . 31]
DECORR=6×HASH_{—}KEY[0 . . . 11]
HASH_{—}KEY=IMSI_{—}O_{—}S1+2²⁴×IMSI_{—}O_{—}S2 [Ex. (3)]

The IMSI for each terminal is a number for uniquely identifying a communication network user, and has a different value for each terminal. Therefore, as shown in FIG. 15, for example, the timings for SWITCHING from THE EV-DO to THE 1x are uniformly distributed within a range of 5.12 seconds. When the reception of the page message performed for each 5.12 seconds fails for several times, it is assumed that the terminal is outside the communication range of the 1x base station, and a search of the 1x base station is performed.

According to a protocol called BCMCS (Broadcast Multicast Service) that is presently available, the same data are transmitted to a specific/unspecific terminal via the EV-DO communication network. According to BCMCS, since the same data can be transmitted to a plurality of terminals via a common communication channel, a communication channel can be effectively employed, compared with when data are transmitted using different communication channels for individual terminals.

Therefore, a large volume of data, such as news or moving pictures, can be distributed using streaming. BCMCS is a streaming service used by the EV-DO system, and streaming data such as data for moving pictures and music data are transmitted downlink (from a base station to a terminal), and the terminal receives these data.

Streaming data transmitted using BCMCS are packet groups, which are not interrupted from the beginning to the end, and a protocol, such as RTP (Real-Time Transport Protocol), can be employed for this transmission. Further, unlike a normal 1x or EV-DO communication, the retransmission of these streaming data is not performed when a transfer error has occurred.

For example, when the EV-DO transmission of BCMCS streaming data is performed using the above described hybrid communication system, a terminal on the reception side must continue to receive the streaming data for which retransmission is not allowed, so that no data will be lost. Therefore, during the reception of streaming data, the antenna can not be changed to the 1x RF circuit, and as shown in FIG. 16, there is a high probability that a page message transmitted by the 1x base station will be lost. When the reception of a page message has failed many times, it is assumed that the terminal is outside the communication range of the 1x base station and another process, such as a search performed for a base station, is started. As a result, the reception of streaming data would become unstable, and the transmission of moving image data and audio data would be discontinued.

There are related arts such as JP-A-2002-171555 and JP-A-2005-86818.

### SUMMARY OF THE INVENTION

The present invention has been made in view of the above circumstances, and provides a communication system, a communication apparatus and a base station for a mobile communication system, whereby a schedule of a base station for the transmission of SCMCS data can be changed in order to reduce the possibility that a situation may occur during which the communication apparatus such as a mobile terminal (mobile phone) fails to receive a 1xPage message during a hybrid operation.

The present invention also provides a communication apparatus that can switch between different communication systems so as to communicate with two base stations, and that can receive messages issued periodically by one of the base stations while stably receiving data such as broadcast data transmitted by the other base station, and a communication method wherein such a mobile communication apparatus can stably transfer data with the base stations.

In some implementations, a communication system of the invention comprises:

a first communication system for broadcasting a content intermittently; and

a second communication system that is monitored periodically by switching from the first communication system,
wherein in the first communication system, the content is transmitted by being divided into packets, and transmission timings of the packets are shifted.

In some implementations, a base station for broadcasting a content by a first communication system comprises:

a transmitter which divides the content into packets and transmits each of the packets intermittently; and

a controller which shifts transmission timings of the packets.

In some implementations, a communication apparatus of the invention comprises:

a first communication section which receives broadcast of a content intermittently;

a second communication section which monitors periodically by switching from the first communication section; and

a controller which performs a control of the switching between the first communication section and the second communication section.

When the communication apparatus such as a mobile terminal (e.g., a mobile phone) is moving, a determination that the mobile is outside the range of the 1x system is avoided whenever possible, and acquisition of a stable reception quality is ensured.

Preferably, in the communication apparatus of the invention, the controller estimates a timing of the switching based on an intermittent broadcasting cycle of the first communication section and a monitoring period of the second communication section.

Preferably, in the communication apparatus of the invention, the controller estimates a timing of the switching by employing a monitoring timing of the second communication section as a reference.

Preferably, in the communication apparatus of the invention, the controller permits the first communication section to receive the broadcast of the content and starts to estimate a timing of the switching, based on program information received by the first communication section.

Preferably, in the communication apparatus of the invention, a monitoring period of the second communication section is longer than a receiving period of the second communication section.

In some implementations, a communication method of the invention comprises:

receiving a broadcast content intermittently by a first communication system;

monitoring a second communication system periodically by switching from the first communication system;

estimating a timing of the switching based on an intermittent broadcasting cycle of the first communication system and a monitoring period of the second communication system; and

controlling the switching based on the estimated timing.

According to the invention, communication can be performed with two base stations by switching between different communication systems, and also, a message periodically-transmitted from one base station can be received, while data such as broadcast data transmitted from the other base station is also stably received.

### BRIEF DESCRIPTION OF THE DRAWINGS

FIG. 1 is a diagram showing a waveform of a switching signal for changing an RF circuit currently being driven in a hybrid operation.

FIGS. 2A to 2C are timing charts showing relationships between BCMCS data and RF circuit switching signals when transmission intervals for BCMCS are shifted.

FIGS. 3A to 3D are timing charts showing relationships between BCMCS data and RF circuit switching signals when transmission intervals of BCMCS data are partially shortened.

FIG. 4 is a timing chart showing the relationship between BCMCS data and individual RF circuit switching signals for a plurality of mobile terminals when the transmission interval for BCMCS data is partially shortened.

FIG. 5 is a circuit block diagram showing the configuration of a mobile terminal of a first embodiment.

FIG. 6 is a flowchart for explaining the operation of the mobile terminal of a first embodiment.

FIG. 7 is a diagram showing the configuration of a mobile communication system of a first embodiment.

FIG. 8 is a block diagram showing the arrangement of a base station in the mobile communication system of a first embodiment.

FIG. 9 is a diagram showing an example configuration for a communication system according to a second embodiment of the present invention.

FIG. 10 is a diagram showing an example arrangement for a mobile communication apparatus of a second embodiment.

FIGS. 11A to 11H are diagrams for explaining the timings for the transmission/reception of a page message.

FIG. 12 is a diagram showing an example arrangement for an EV-DO base station of a second embodiment.

FIG. 13 is a flowchart for explaining the operation of the mobile communication apparatus of a second embodiment.

FIG. 14 is a timing chart showing timings for the reception of page messages.

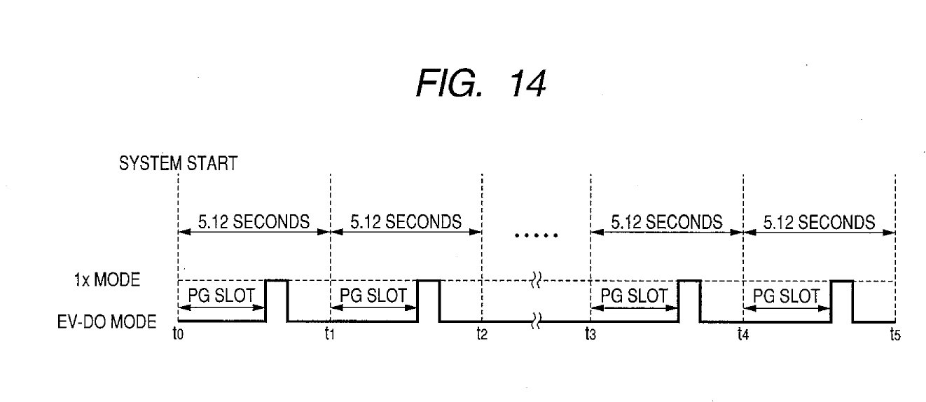

FIG. 15 is a timing chart showing the message reception timings for a plurality of mobile terminals.

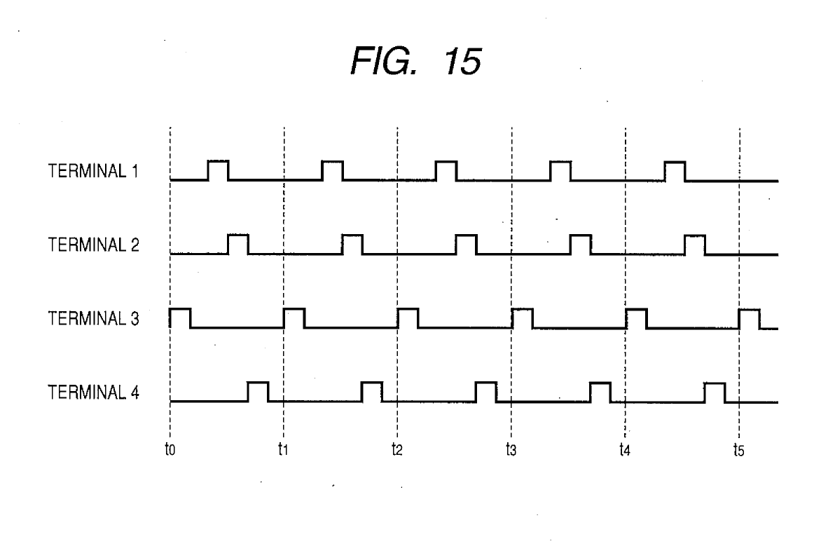

FIG. 16 is a timing chart showing timings for the reception of BCMCS data.

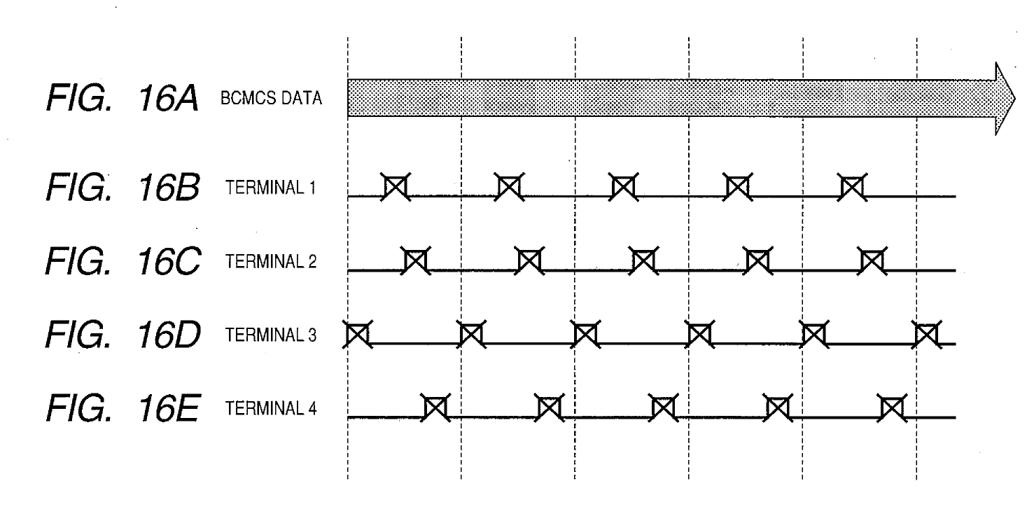

### DESCRIPTION OF THE PREFERRED EMBODIMENTS

### First Embodiment

In related arts, BCMCS data are transmitted over all slots (64 slots) of 5.12 second, while in one embodiment of this invention, BCMCS data are transmitted at predetermined intervals m (e.g., each 80 ms slot).

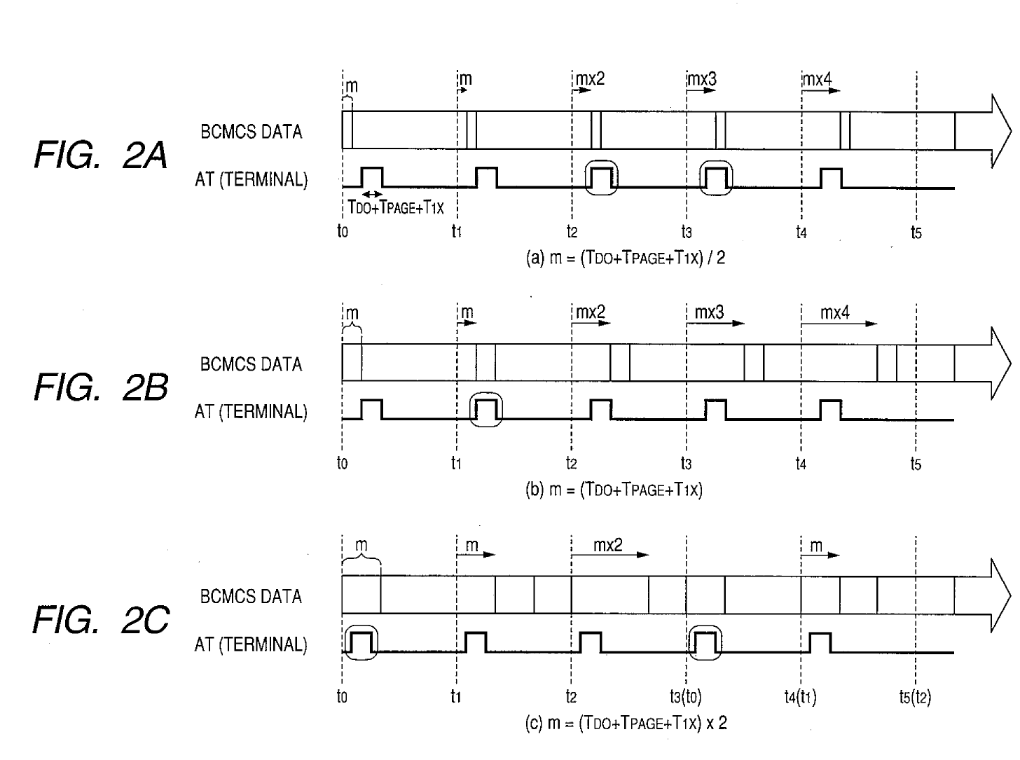

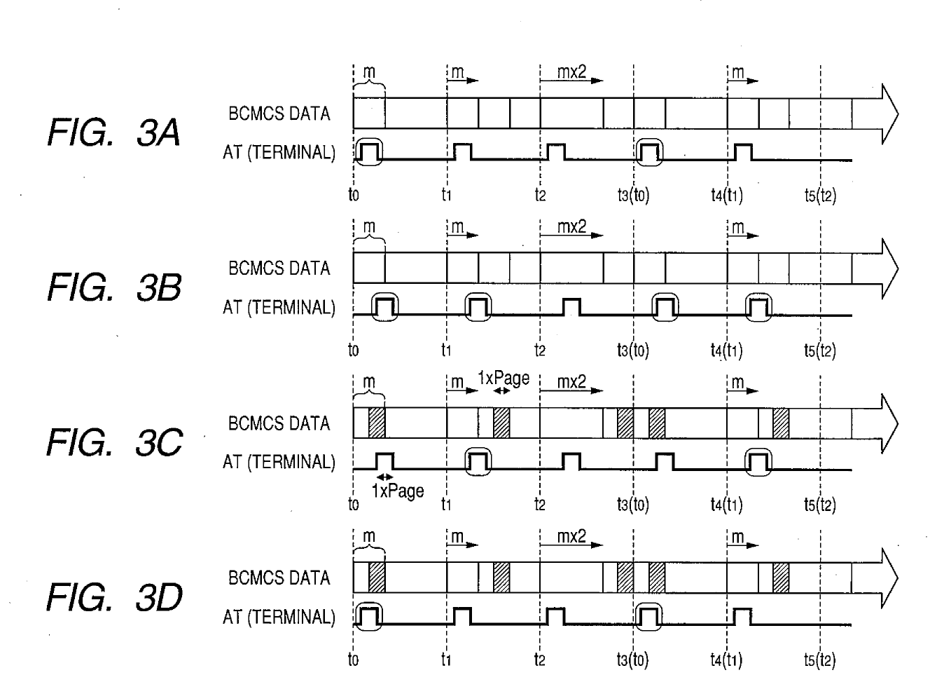

Further, for each slot cycle, the timing for the transmission of BCMCS data is shifted using a time m (FIGS. 2 and 3). The value for m is determined as follows.

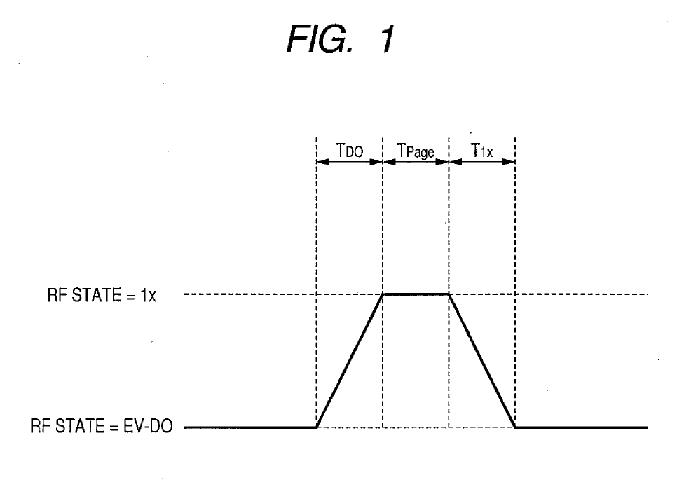

The system switching state of an RF circuit during the hybrid operation is shown in FIG. 1.

When a low level is defined as the EV-DO system reception time, and a high level is defined as the 1x system reception time, a leading time from the low level can be denoted by T_{DO}, the 1x system reception available time an be denoted by T_{Page}, and the trailing time can be denoted by T₁ₓ.

The time T_{DO} and the time T₁ₓ are required when there is a switch from the 1x system to the EV-DO system, or when there is a switch from the EV-DO system to the 1x system. Since these times can vary depending on differences in the individual terminals, the temperature, and the radio wave conditions, they are not always constants.

As described above, actually, the extra switching times T_{DO} or T₁ₓ is required to switch from the EV-DO system to the 1x system, or from the 1x system to the EV-DO system.

FIGS. 2A to 2C are diagrams showing relationships between the timing for the transmission of BCMCS data and the timing for the switching of the RF circuit of a communication apparatus (a mobile terminal) such as a mobile phone.

Specific examples wherein various values are designated for m are shown.

In FIG. 2A, the value set for m is smaller than the total value for T_{DO}+T_{Page}+T₁ₓ, e.g., m=(T_{DO}+T_{Page}+T₁ₓ)/2.

For every 5.12 seconds (each slot cycle), the transmission timing for BCMCS data in the 1x system is shifted, at a time t0, an interval of 0*m; at a time t1, an interval of 1*m; at a time t2, an interval of 2*m; and at a time tn, an interval of n*m. On the other hand, a switching signal for the RF circuit of an AT (a terminal, such as a portable terminal) is repetitively output in an almost constant cycle of 5.12 seconds.

Then, in the period between time t2 and t3 and in the period between time t3 and t4, m for BCMCS data and the RF switching signal (waveform) of the AT overlap (hereinafter also referred to as a collision). This collision may sequentially occur at the 1x Page reception timing.

In the example in FIG. 2B, the value of m is equal to the total for T_{DO}+T_{Page}+T₁ₓ.

The value of m is twice the value m in FIG. 2A, and for every 5.12 seconds, the transmission timing for BCMCS data is shifted by employing integer times the value m as an interval.

While the value of m is large, the time area wherein the m collides with the RF circuit switching signal from the AT is smaller than that in FIG. 2A, i.e., the collusion occurs only in the period between times t1 and t2. Further, since a collusion between the transmission of BCMCS data and the RF circuit switching signal does not occur continuously equal to or more than two times, this does not affect the 1x Page reception of the AT.

In the example in FIG. 2C, the value set for m is 2*(T_{DO}+T_{Page}+T₁ₓ).

The value of m is twice the value of m in FIG. 2B. The period for the transmission of BCMCS data is extended, and the period within which the BCMCS data collide with the RF circuit switching signal of the AT is shortened (a repetitive cycle of 5.12 seconds).

For example, first, the transmission of BCMCS data is started at time t0, and then the transmission timing is shifted by the interval m for every 5.12 seconds. At time t3, shifting of m starts at the start time (t0) of 5.12 seconds again.

Compared with the example in FIG. 2B, the number of collisions between BCMCS data and the RF circuit switching signal is increased; however, continuous collisions do not occur, so that the 1x Page reception by the AT is not adversely affected.

As described above, the value of m is equal to or greater than the total value of T_{DO}+T_{Page}+T₁ₓ, and as shown in FIG. 2B or 2C, a collision of the BCMCS data and the RF circuit switching signal transmitted by the AT rarely occurs.

Therefore, the minimum value of m is defined as the total value of T_{DO}+T_{Page}+T₁ₓ.

FIG. 3A is a diagram showing an example wherein the switching timing for an RF circuit switching signal of the AT (a communication apparatus or a portable terminal) is shifted.

In FIG. 3A, as long as the 1x Page timing falls within the range represented by m, the overlapping of the timing for the transmission of 1x Page and the timing for the transmission of BCMCS data can be minimized. In this case, only during the period between time t0 and t1 and during the period between time t3 (t0) and t4 (t1) have collisions of the BCMCS data and the RF circuit switching signal occurred; however, continuous collisions do not occur.

However, as shown in FIG. 3B, when the transmission timing for the RF circuit switching signal of the AT is shifted, even slightly, from the transmission timing for the BCMCS data, collisions occur continuously. According to the example in FIG. 3B, in the period between time t0 and t1, the period between t1 and t2, the period between t3 (t0) and t4 (t1), and the period t4 (t1) and t5 (t2), the transmission of BCMCS data sequentially collides with the RF circuit switching signal.

Thus, as shown in FIG. 3C, the transmission timing for the BCMCS data is shifted a length equivalent to the period m (in the same manner as in FIG. 3A), and the period required for one transmission is reduced by a time equivalent to the shaded portion in the period m, i.e., for the portion 1x Page (T_{DO}+T_{Page}+T₁ₓ).

The result obtained by reducing a length equivalent to 1xPage (T_{DO}+T_{Page}+T₁ₓ) from m is shown in FIG. 3C. This example corresponds to FIG. 3B, and the collisions in FIG. 35 in the period between t0 and t1 and the period between t3 (t0) and t4 (t1) have disappeared.

Therefore, continuous collisions can be avoided, and the affect on 1x Page receptions by the AT can be reduced.

In the example in FIG. 3D, m in FIG. 3A is reduced by a length equivalent to 1xPage (T_{DO}+T_{Page}+T₁ₓ).

In this case, the timing at which BCMCS data collide with the RF circuit switching signal does not change.

By referring to above description, a BCMCS transmission start position range θ₁ and a transmission end position range θ₂ are represented as follows.

$$range {θ}_{1} = ( \frac{⌊ t / 4 ⌋ - ( ⌊ t / 4 ⌋ mod ( 16 \times T ) )}{16 \times T} + Offset ) \times m \\ range {θ}_{2} = ( \frac{⌊ t / 4 ⌋ - ( ⌊ t / 4 ⌋ mod ( 16 \times T ) )}{16 \times T} + Offset ) \times ( m + 1 ) - ( {T}_{DO} + {T}_{Page} + {T}_{1 x} ) \qquad [ Ex . ( 4 ) ]$$

wherein “Offset” is a value that is incremented for each set of BCMCS data, and the range for “Offset” is represented by the following expression.

$$Offset = 0 to \frac{16 \times T - ( ( 16 \times T ) mod m )}{m} - 1 \qquad [ Ex . ( 5 ) ]$$

wherein m falls within the following range.
m≧T_{DO}+T_{page}+T₁ₓ
wherein range θ₁ and range θ₂ denote 1x frame unit of one slot of 80 ms.

In the above example, the transmission timing is only shortened a length equal to the 1x Page monitoring period. However, the transmission timing can be shortened a period that exceeds the monitoring period, and a change in the transmission timing is not limited to these values.

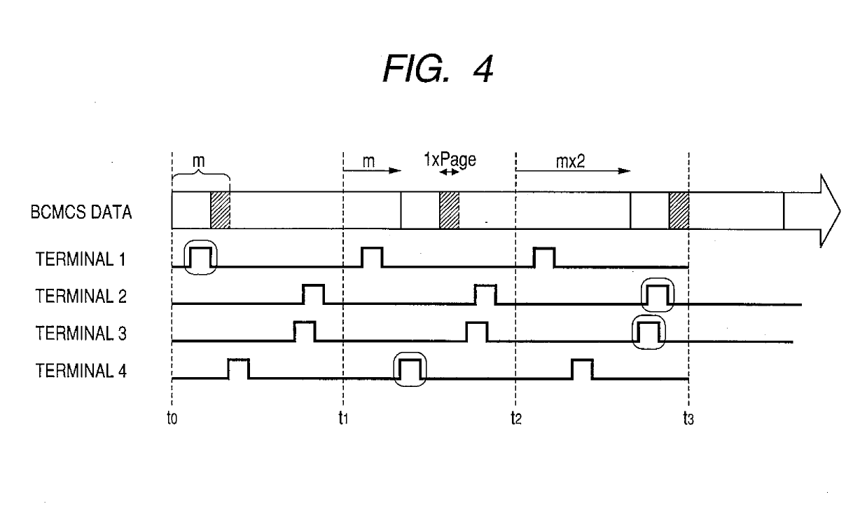

FIG. 4 is a diagram showing an example, for this embodiment, wherein a plurality of communication apparatuses, such as portable terminals (mobile phones), receive BCMCS data.

BCMCS data are designated at locations obtained by reducing m by 1x Page, and by sequentially shifting the transmission timing for the interval m in consonance with the repetitive cycle. Further, the RF circuit switching signal timings for the individual portable terminals (terminal 1 to terminal 4) are shown.

For terminal 1, a collision between BCMCS data and the RF circuit switching signal occurs only in the period between t0 and t1. For terminals 2 and 3, a collision occurs only in the period between t2 and t3. And for terminal 4, a collision occurs only in the period between t1 and t2.

As is apparent from FIG. 4, even when the number of terminals that receive BCMCS data is increased the 1xPage reception operations of all of the terminals are not adversely affected.

In this example, m is reduced by a value equivalent to the monitoring period for 1x Page. However, m may be shortened even more than the monitoring period, and the change is not limited to these values.

It should be noted that for an actual operation, when the value of m is too small, it is not practical, because the amount of BCMCS data that can be transmitted is too small.

Furthermore, when a too large value is designated for m, the BCMCS data transmission timing frequently overlaps the transmission timing for a 1x Page message, and in order to prevent the occurrence of this phenomenon, the optimal value for m must be dynamically changed, depending on the number of communication terminals or the communication conditions.

Since a way of permitting a communication apparatus (a terminal, such as a mobile phone) and a base station to negotiate the value of m and the value of Offset has not yet been established, the following several ways are presented.

(1) The value of m and the value of Offset are defined as system parameters, and when an EV-DO session is established, negotiations are performed.

(2) A field for storing a value form is added to a broadcast overhead message, which is a BCMCS information notification transmitted by a base station to a terminal (a communication apparatus).

(1) Terminal Operation

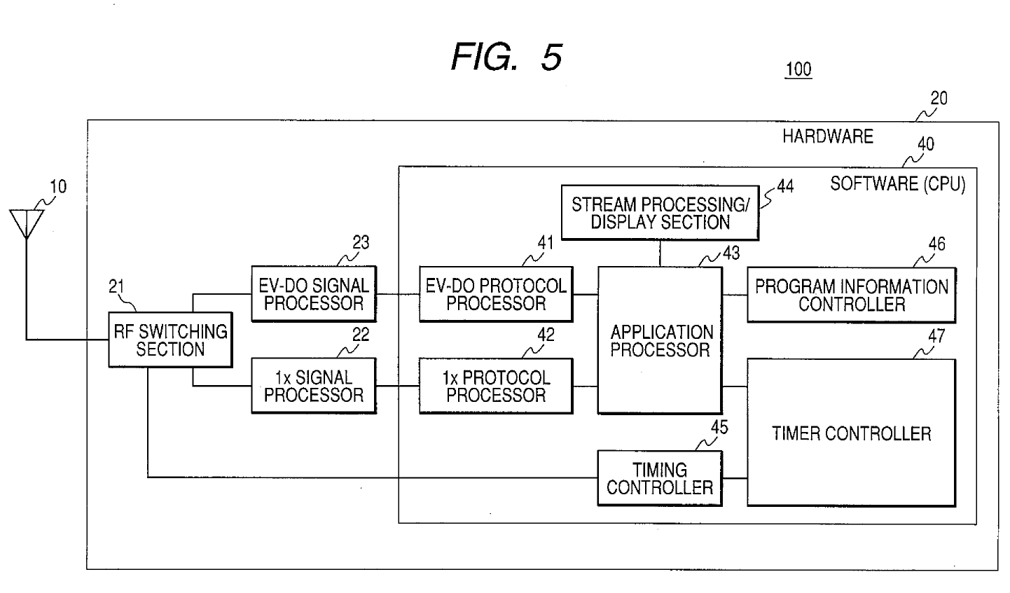

The above described change operation will be specifically described for a terminal (a communication apparatus) while referring to FIG. 5.

The block for a (portable) terminal 100 in FIG. 5 includes: an antenna 10, hardware 20 and software 40. The hardware 20 includes an RF (circuit) switching section 21, an EV-DO signal processor 23, a 1x signal processor 22, and a CPU (a micro computer) that employs the software 40 to perform operations.

The software (CPU) 40 includes as functions an EV-DO protocol processor 41, a 1x protocol processor 42, an application processor 43, a stream processing/display section 44, a timing controller 45, a program information controller 46 and a timer controller 47.

The timer controller 47 monitors a system time, and permits the timing controller 45 to change a mode to the 1x mode every slot cycle of 5.12 seconds.

The timing controller 45 instructs the RF (circuit) switching section 21 to set the 1x or EV-DO mode.

The RF circuit switching section 21 employs a switch to change an RF circuit to either the 1x mode or the EV-DO mode. When the mode is changed to the EV-DO mode, the EV-DO signal processor 23 starts the exchange of radio data, and when the mode is changed to the 1x mode, the 1x signal processor 22 starts the exchange of radio data.

The EV-DO protocol processor 41 and the 1x protocol processor 42, which constitute part of the software 40, handle radio control messages and perform processes such as a framing process and linking process.

These five blocks, i.e., the RF circuit switching section 21, the 1x signal processor 22, the EV-DO signal processor 23, the EV-DO protocol processor 41 and the 1x protocol processor 42 are tasked with the processing performed from the physical layer up to the application layer with respect to radio communication.

The application processor 43 handles data, mainly PPP (point-to-point protocol)/IP (internet protocol)/TCP (transmission control protocol) packets received from the radio layer.

The program information controller 46 obtains program information of the available BCMCS data, and controls the BCMCS protocol in accordance with the contents of a program. The program information includes a starting time and an end time, and format and an identification number for BCMCS data.

The stream processing/display section 44 employs the obtained BCMCS data to display or reproduce moving picture data or audio data.

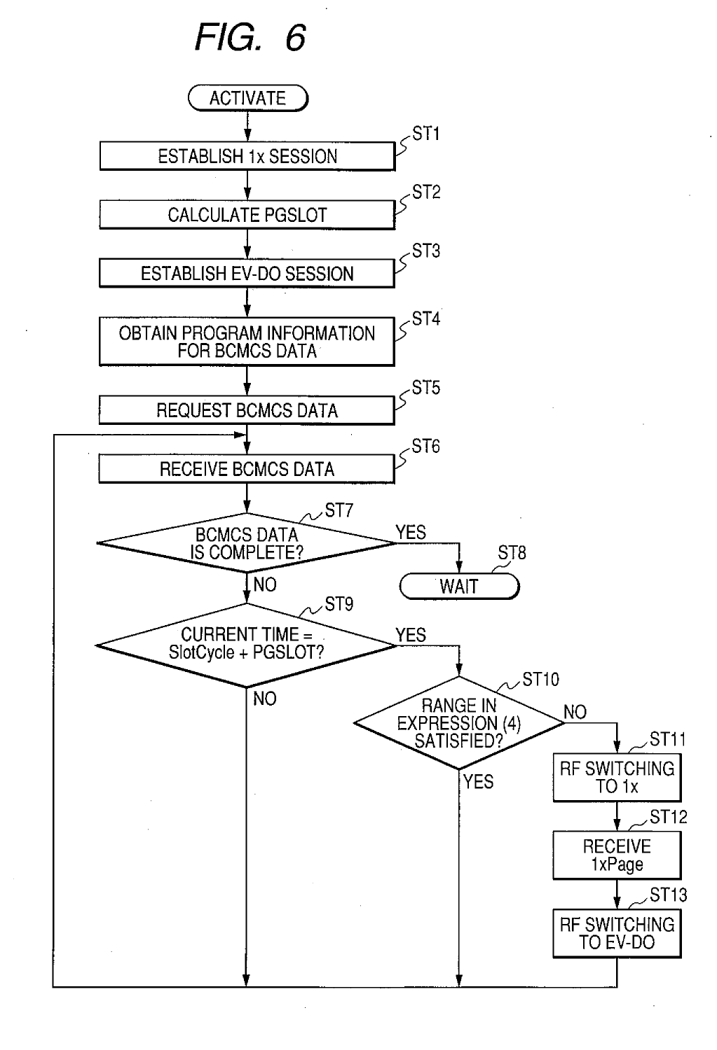

FIG. 6 is a flowchart showing a specific operation performed when a communication apparatus (a portable terminal) is activated and receives BCMCS data.

Step ST1:

When the terminal is activated, at first, the terminal initializes various internal parameters, employs the RF circuit switching section 21 to change the RF circuit (21) to the 1×mode, and negotiates with the base station to establish the 1x session.

Step ST2:

The timing controller 45 in FIG. 5 calculates normal PGSLOT, and saves parameters.

Step ST3:

The RF circuit switching section 21 is changed to the EV-DO mode, and negotiations with the EV-DO base station are performed to establish the EV-DO session.

Steps ST4, ST5 and ST6:

The terminal obtains a program table (program information) in order to receive BCMCS data, and requests a program from the base station. Then, the transmission of BCMCS data by the base station is started.

Step ST7:

A check is performed to determine whether the reception of BCMCS data is completed.

Step ST8:

When the reception of BCMCS data is completed, the terminal enters an idle state.

Step ST9:

When the reception of BCMCS data is completed at step ST7, the timer controller 47 continuously performs monitoring to determine whether the current time is SlotCycle+PGSLOT (1xPage reception time of every 5.12 seconds).

Step ST10:

The timer controller 47 determines whether the current time, SlotCycle+PGSLOT, has been satisfied.

Steps ST11 to ST13:

When the timer controller 47 determines that the current time, SlotCycle+PGSLOT, has been satisfied, the RF circuit switching section 21 switches the RF circuit to the 1x mode, the 1x Page message is received (step ST12), and the RF circuit is returned to the EV-DO mode (step ST13).

When, at step ST10, the current time is within the range represented in (4), the above processes are not performed and program control returns to step ST6.

This process sequence is repeated until the scheduled end time for the reception of BCMCS data is reached.

(2) Base Station Operation

The base station side operation will now be described.

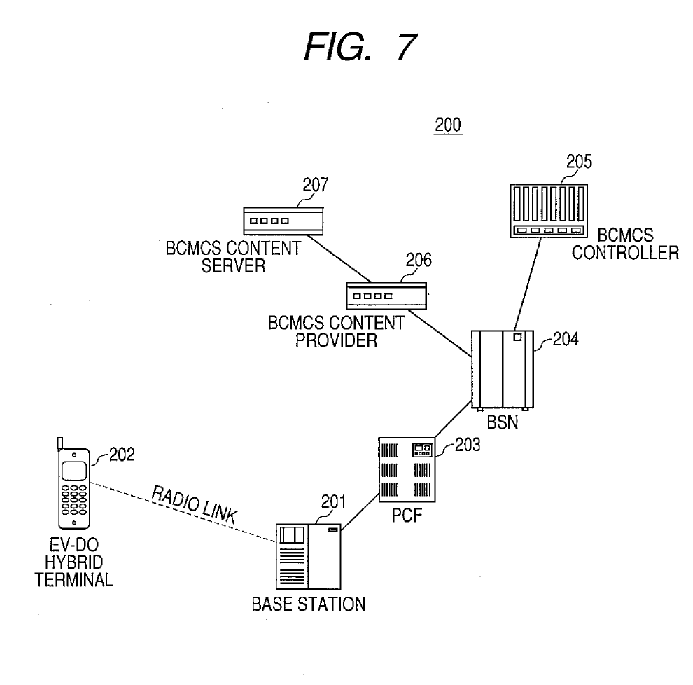

FIG. 7 is a diagram showing a configuration for an EV-DO network 200 to which a base station belongs.

The EV-DO network 200 is constituted, for example, by a base station 201, an EV-DO hybrid terminal 202, a PCF (point coordination function) 203, a BSN 204, a BCMCS controller 205, a BCMCS content provider 206 and a BCMCS content server 207.

The base station 201 controls the radio protocol for the EV-DO network 200.

The PCF 203 manages an EV-DO session, and the BSN 204 is a conversion gateway for an IP network and a radio network that are compatible with BCMCS.

The BCMCS content provider 206 is an intermediate server that performs framing, encrypting or encoding for streaming content.

The BCMCS content server 207 is a point for the generation of streaming content.

Finally, the SCMCS controller 205 manages a BCMCS session and program table data.

The base station 201 moves BCMCS data received from the PCF 203 to an EV-DO radio frame, and transmits this frame as radio data.

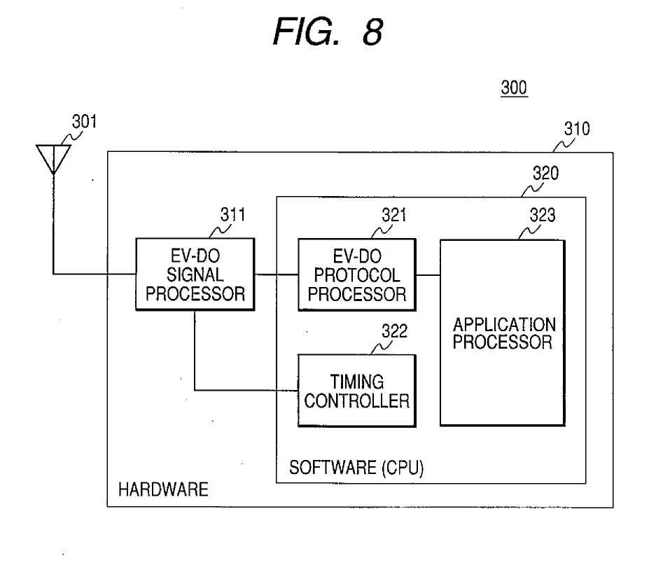

FIG. 8 is a block diagram showing the arrangement of a base station (side) 300.

A base station 300 includes an antenna 301, hardware 310 and software (CPU) 320.

The hardware 310 includes an EV-DO signal processor 311 and a CPU (a micro computer) that employs software to perform operations.

The software (CPU) 320 includes an EV-DO protocol processor 321, a timing controller 322 and an application processor 323.

The timing controller 322, which is a part of the software (CPU) 320, instructs a timing for the transmission of BCMCS data.

As shown in FIGS. 3C and 3D, this timing is obtained, for example, by reducing the above described m by 1x Page, and by sequentially shifting the timing in the PGSLOT cycle at intervals of m. Therefore, for a plurality of terminals, for example, the RF circuit switching signals and timings do not collide with each other.

In the examples in FIGS. 3C and 3D, the packet transmission timing has been shifted by a length equivalent to the 1x Page monitoring period on the reception side (e.g., a communication apparatus, such as the EV-DO hybrid terminal). However, the shift for the transmission timing may be greater than the monitoring period, and the shift is not limited to the values referred to here.

The EV-DO signal processor 311 exchanges radio data, and the EV-DO protocol processor 321 handles radio control messages and performs framing and linking processes. These two blocks are tasked with the processing performed from the physical layer up to the application layer that are related to radio communication.

The application processor 323 processes data, mainly PPP/XP/TCP packets, received from the radio layer.

As described above, BCMCS data are transmitted through all the 5.12 second slots (64 slots) in the related arts, while in this invention, BCMCS data are transmitted at predetermined intervals m (e.g., every 80 ms slot), and further, for each slot cycle, the transmission timing for BCMCS data is shifted by m.

As a result, the sequential collision of the BCMCS data transmitted by the base station and the RF circuit switching signals of the individual mobile terminals can be prevented.

Therefore, while a mobile terminal is moving across a cell boundary, the probability that the terminal will be determined to be outside the range of the 1x system is avoided whenever possible, and a stable reception quality can be obtained.

### Second Embodiment

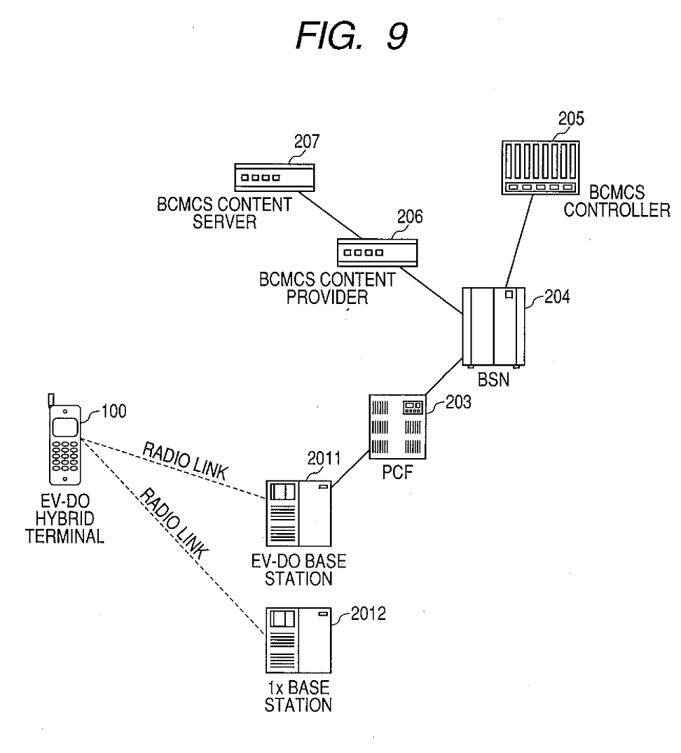

FIG. 9 is a diagram showing an example configuration for a communication system according to one embodiment of the present invention.

The communication system in FIG. 9 includes: a mobile communication apparatus 100, an EV-DO base station 2011 and a 1x base station 2012.

The mobile communication apparatus 100 is connected to the 1x base station 2012 for radio communication, and performs voice communication with another telephone via the 1x base station 2012 and a line switching network (not shown).

Further, the mobile communication apparatus 100 is connected to the EV-DO base station 2011 for radio communication, and performs data communication with another communication terminal or a server apparatus via a packet switching network, such as an IP (Internet Protocol) network.

The mobile communication apparatus 100 can communicate by radio with either the EV-DO or the 1x base station, and can not communicate with both base stations at the same time. When voice communication is being performed using the 1x communication system, every slot cycle (64 slots 5.12 seconds) the communication system is switched from the 1x to the EV-DO base station to monitor the control channel, and a message transmitted by the EV-DO base station 2011 is received. When data communication is being performed using the EV-DO communication system, each slot cycle the communication system is switched from EV-DO to 1x to monitor the page channel, and a message transmitted by the 1x base station 2012 is received.

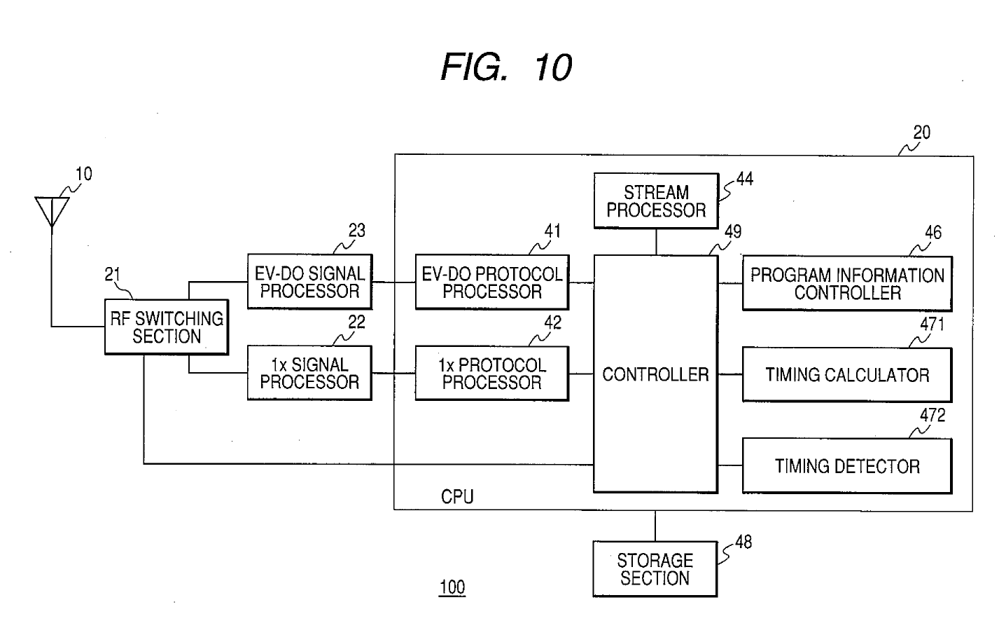

FIG. 10 is a diagram showing an example configuration for the mobile communication apparatus 100.

The mobile communication apparatus 100 in FIG. 10 includes: an antenna 10, an RF switching section 21, an EV-DO signal processor 23, a 1x signal processor 22, a CPU 20 and a storage section 48. Further, the mobile communication apparatus 100 includes, as a function block provided by the software processing performed by the CPU 20, an EV-DO protocol processor 41, a 1x protocol processor 42, a stream processor 44, a program information controller 46, a timing calculator 471, a timing detector 472 and a controller 49.

The EV-DO signal processor 23 performs signal processing, such as amplification, frequency conversion, analog-digital conversion and demodulation for an EV-DO input signal that is received from the antenna 10 via the RF switching section 21, and transmits to the CPU 20 the EV-DO data that are received and the results obtained by the signal processing. In addition, the EV-DO signal processor 23 performs signal processing, such as modulation, digital-analog conversion, frequency conversion and amplification, for EV-DO data that are to be output by the CPU 20, and transmits to the antenna 10, via the RF switching section 21, a transmission signal in the RF band that is a result provided by the signal processing.

The 1x signal processor 22 performs signal processing, such as amplification, frequency conversion, analog-digital conversion and demodulation, for a 1x input signal that has been received from the antenna 10 via the RF switching section 21, and transmits, to the CPU 20, 1x data that are a result provided by the signal processing. Further, the 1x signal processor 22 performs signal processing, such as modulation, digital-analog conversion, frequency conversion and amplification, for 1x data that are to be output by the CPU 20, and transmits to the antenna 10, via the RF switching section 21, a transmission signal in the RF band that is a result provided by the signal processing.

Under the control of the CPU 20, the RF switching section 21 selects either the EV-DO signal processor 23 or the 1x signal processor 22 for connection to the antenna 10.

The CPU 20 performs various processes and exercises control in accordance with program codes stored in the storage section 48. For example, the CPU 20 performs software processing to provide functions, such as the EV-Do protocol processor 41, the 1x protocol processor 42, the stream processor 44, the program information controller 46, the timing calculator 471, the timing detector 472 and the controller 49, which will be described later.

The storage section 48 is used to store the program code for the CPU 20 and various other data, such as variable data and constant data, employed for the processing performed by the CPU 20. For example, IMSI is stored as identification information used for the identification of a terminal.

The EV-DO protocol processor 41 and the 1x protocol processor 42 perform processes related to the respective EV-DO and 1x communication protocols. For example, processes are performed for radio control messages and for framing and linking.

The five blocks, i.e., the RF switching section 21, the EV-DO signal processor 23, the 1x signal processor 22, the EV-DO protocol processor 41 and the 1x protocol processor 42, control processing performed from the physical layer up to the application layer related to radio communication.

The program information controller 46 obtains available BCMCS program data from a BCMCS controller 206, via the EV-DO base station 2011 that is currently connected, and controls the BCMCS communication protocol in consonance with the program data content that is obtained. The program data includes: the start time and the end time for the transmission of BCMCS data, a data format type and an identification number.

The stream processor 44 decodes image data and audio data included in BCMCS streaming data that are obtained, via the EV-DO base station 2011, from a BCMCS content server 207. Further, the stream processor 44 performs a process for displaying decoded image data as images on a display device (not shown), or a process for outputting, through a loudspeaker (not shown), decoded audio data as sounds.

The timing calculator 471 calculates a timing for the reception of a page message that is transmitted by the 1x base station 2012.

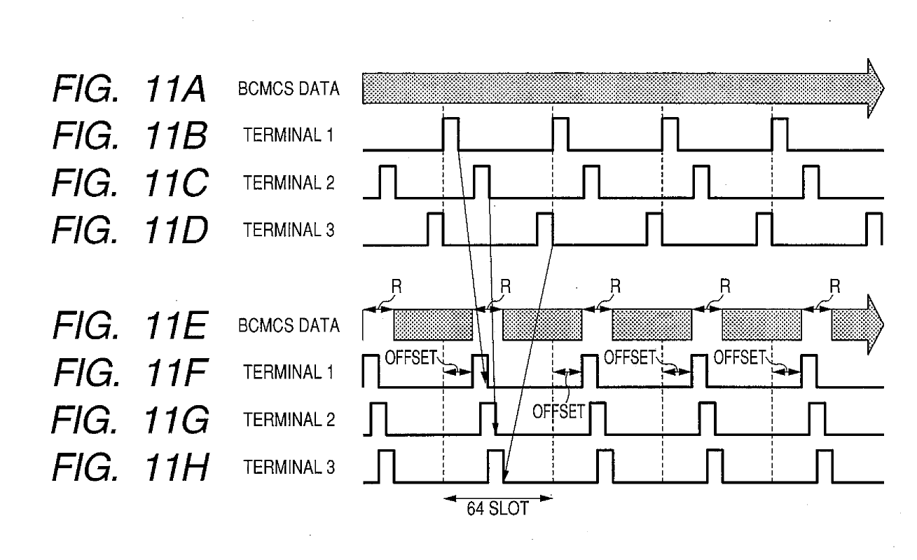

FIGS. 11A to 11H are diagrams for explaining timings for the transmission and reception of a page message.

By referring to examples in FIGS. 11A to 11D, timings for the transmission/reception of a page message are determined based on a PGSLOT represented by expression (1). In this case, the transmission/reception timings are uniformly distributed during the entire period of one slot cycle (64 slots=5.12 seconds). Therefore, when BCMCS streaming data are transmitted sequentially by the EV-DO base station 2011 (FIG. 11A), the transmission of a page message by the 1x base station 2012 and the transmission of streaming data by the EV-DO base station 2011 would be performed at the same time (FIGS. 11B to 11D) Since the terminal can not receive, at the same time, a page message transmitted using the 1x system and streaming data transmitted using the EV-DO system, the terminal will fail to receive either 1x or EV-DO data when they are transmitted at the same time.

On the other hand, referring to FIGS. 11E to 11H, timings for the transmission/reception of a page message are limited to a specific period within a slot cycle, instead of being performed during the entire period. This is provided by employing, for example, a PGSLOT represented by the following expression (3), instead of the PGSLOT in expression (2), to determine the transmission/reception timings.

$$PGSLOT = {PGSLOT}_{normal} \frac{R}{64} + Offset \qquad [ Ex . ( 7 ) ]$$

In expression (7), “PGSLOTₙₒᵣₘₐₗ” denotes a PGSLOT obtained by expression (2).

“R” denotes a numerical value indicating a period of time in one slot cycle (64 slots ˜5.12 seconds) during which a page message is transmitted or received, and the unit is a single slot (one slot=80 Mas). “R” is set as a positive integer that is smaller than 64.

“Offset” denotes a numerical value indicating a distance along a time axis whereat the starting point of a period indicated by “R” is separate from the starting point for one slot cycle. Here, a unit is a slot.

When a timing for the transmission/reception of a page message is determined by the PGSLOT represented in expression (3), the timings for the individual terminals (mobile communication apparatuses 10) are collected from the entire period for one slot cycle (64 slots) to one specific period (the period of an R slot) (FIGS. 11F to 11H). As shown in FIG. 3E, since the EV-DO base station 2011 temporarily halts the transmission of BCMCS data during the R slot periods, a mobile communication apparatus 100 that is receiving BCMCS streaming data can receive a page message without failing to receive streaming data.

The timing calculator 471, for example, calculates the PGSLOT represented in expression (1) based on the IMSI that is stored in the storage section 48, and converts the obtained results into the PGSLOT represented in expression (7). Through this process, a page message reception timing that is limited to a specific period (an R slot period) during one slot cycle (64 slots) can be obtained.

When communication with the 1x base station 2012 is begun, the timing detector 472 detects the arrival of the page message reception timing that is obtained by the timing calculator 471.

For example, when communication with the 1x base station 2012 is begun, the timing detector 472 obtains, from the 1x base station 2012, the timing for the starting point of a slot cycle. The timing for the starting point is detected by using, for example, the timer function provided for the CPU 20. When the starting points for slot cycles are detected every 5.12 seconds (64 slots), the timing detector 472 detects a point, separated from the timing for the starting point by a distance equivalent to the PGSLOT that is obtained by the timing calculator 471, and transmits this point to the controller 49 as a page message reception timing.

The controller 49 employs various related processes for all the operations that are performed by the mobile communication apparatus 100.

The controller 49 employs related processes for communication protocols, such as PPP (Point-to-Point Protocol), IP (Internet Protocol) or TCP (Transmission Control Protocol), for data, received or to be transmitted, that are processed by the EV-DO protocol processor 41 or the 1x protocol processor 42.

Furthermore, when the timing detector 472 detects the arrival of a page message reception timing, while the EV-DO signal processor 23 and the EV-DO protocol processor 41 are receiving BCMCS data from the EV-DO base station 2011, the controller 49 permits the RF switching section 21 to switch from the EV-DO signal processor 23 to the 1x signal processor 22, which is thereby connected to the antenna 10, and reception by the 1x signal processor 22 and the 1x protocol processor 42 is started. The 1x page channel is monitored for a predetermined period of time (one slot), and page messages transmitted by the 1x base station 2012 are received. Thereafter, the controller 49 permits the RF switching section 21 to switch from the 1x signal processor 22 to the EV-DO signal processor 23, which is thereby again connected to the antenna 10, and the reception of SCMCS data by the EV-DO signal processor 23 and the EV-DO protocol processor 41 is resumed.

The mobile communication apparatus 100 has been described.

Referring again to FIG. 9, the 1x base station 2012, using the 1x radio communication facilities, establishes a connection with the terminal (the mobile communication apparatus 100) and relays, as voice communication that is performed between the terminal and another telephone via a line switching network (not shown).

In order to notify the terminal (the mobile communication apparatus 100) that a signal has arrived, for each slot cycle (64 slots=5.12 seconds) the 1x base station 2012 transmits a page message to each terminal that is connected. As shown in FIGS. 11A to 11H the timing for the transmission of a page message is limited to specific periods (periods for R slots) during a slot cycle.

For example, before a connection has been established, the 1x base station 2012 obtains the IMSI for each terminal, and employs the IMSI to calculate, for each terminal, a PGSLOT represented in expression (7). Then, the timing for the transmission of a page message to each terminal is determined based on the PGSLOT obtained for the terminal.

The EV-DO base station 2011 establishes a connection to the terminal (mobile communication apparatus 100) using the 1x radio communication, and relays data for communications performed between this terminal and another terminal, or a server apparatus, via a packet switching network.

As shown in FIG. 9, network apparatuses, such as a PCF 203, a BSN 204, a BCMCS content provider 206, a BCMCS content server 207 and a BCMCS controller 206, are connected to the data communication network to which the EV-DO base station 2011 is connected.

The PCF 203 manages an EV-DO session.

The BSN 204 is a conversion gateway for an IP network compatible with the BCMCS and a radio network.

The BCMCS content provider 206 is an intermediate server that performs the framing, encrypting or encoding of streaming content.

The BCMCS content server 207 is a generation point for streaming content.

The BCMCS controller 206 manages a BCMCS session and program table data.

The EV-DO base station 2011 moves BCMCS data, received from the PCF 203, to an EV-DO radio frame, and transmits this frame as radio data.

Furthermore, the EV-DO base station 2011 temporarily halts the transmission of BCMCS data for a specific period (a period equivalent to the timing for the R slot) in one slot cycle, during which the 1x base station 2012 transmits a page message (FIG. 11E). When the page message transmission/reception timing is defined by the PGSLOT in expression (7), the period during which the EV-DO base station 2011 transmits BCMCS data is designated so that it does not overlap the period for the R slot, which is positioned within a range, extending from “Offset” to “Offset+R”, for the starting point of one slot cycle.

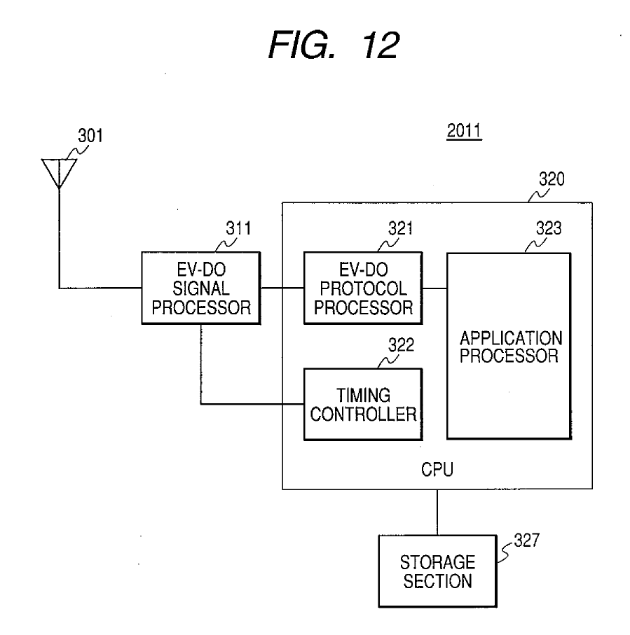

FIG. 12 is a diagram showing an example arrangement for the EV-DO base station 2011.

As shown in FIG. 12, the EV-DO base station 2011 includes an antenna 301, an EV-DO signal processor 311, a CPU 320 and a storage section 327. Furthermore, the EV-DO base station 2011 includes, as a functional block provided by the software processing performed by the CPU 320, an EV-DO protocol processor 321, a timing controller 322 and an application processor 323.

The EV-DO signal processor 311 performs signal processing, such as the amplification, signal conversion, analog-digital conversion and demodulation of an EV-DO signal that is received at the antenna 301 and is transmitted to the CPU 320, and of the EV-DO data that constitute the results obtained by the signal processing. The EV-DO signal processor 311 also performs signal processing, such as modulation, digital-analog conversion, frequency conversion and amplification, for EV-DO transmission data that are output by the CPU 320, and transmits to the antenna 301, in the RF band, a transmission signal that is the result obtained by the signal processing.

The CPU 320 performs various processes and provides controls in accordance with program codes stored in the storage section 327. The CPU 320 performs software processing to provide functions, such as the EV-DO protocol processor 321, the timing controller 322 and the application processor 323, which will be described later.

The storage section 327 is used to store program codes for the CPU 320 and certain other data, such as variable data and constant data, employed for the processing performed by the CPU 320. For example, the BCMCS data to be transmitted from the BCMCS content server 207 to a terminal are temporarily stored in the storage section 327.

The EV-DO protocol processor 321 performs processes related to the EV-DO communication protocol, such as a radio control message process, a framing process and a linking process. The two blocks, i.e., the EV-DO signal processor 311 and the EV-DO protocol processor 321, provide control for the processing, from the physical layer to the application layer, that is related to EV-DO radio communication.

The application processor 323 performs the processing related to the communication protocol, such as PPP (Point-to-Point Protocol), IP (Internet Protocol) or TCP (Transmission Control Protocol), for the received data or for data to be transmitted that are processed by the EV-DO protocol processor 321.

The timing controller 322 performs a process for the instruction of a BCMCS data transmission timing. The timing for the transmission of BCMCS data is so instructed that, as shown in FIG. 11E, for example, during the entire period provided for a slot cycle, the transmission timing does not overlap a specific period (that allocated for an R slot) during which a page message is transmitted.

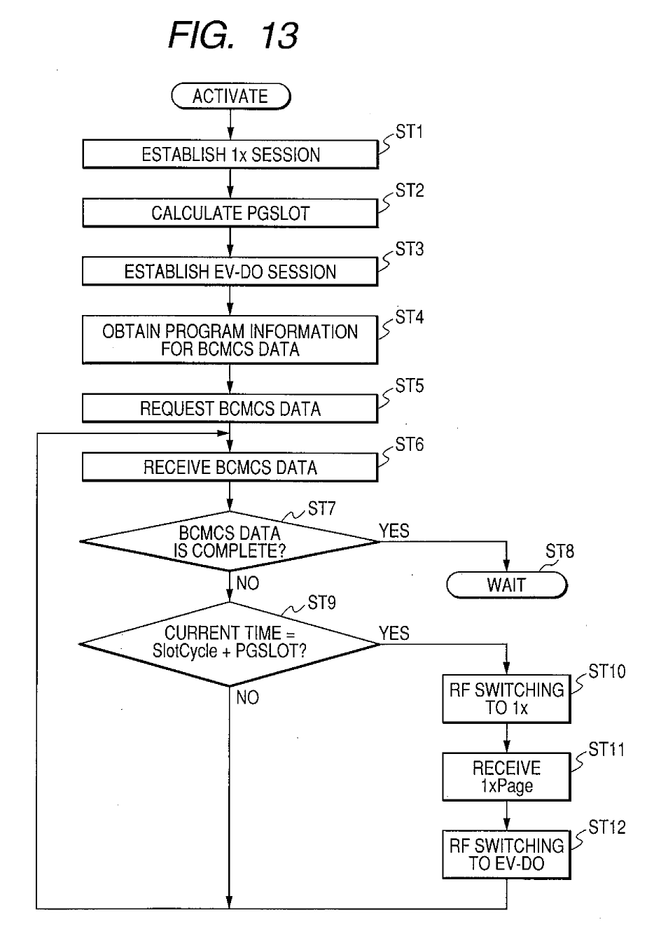

The operation of the mobile communication apparatus 100 having the above described arrangement as shown in FIG. 10 will now be explained while referring to a flowchart in FIG. 13.

Step ST1:

When power is switched on, the controller 49 initializes various internal parameters.

After this initialization has been performed, the controller 49 permits the RF switching section 21 to connect the 1x signal processor 22 to the antenna 10, and starts the 1x communication using the 1x signal processor 22 and the 1x protocol processor 42. Then, a neighbor 1x base station 2012 is searched for, and transmission negotiation is performed to establish a 1x communication session for the 1x base station 2012.

Step ST2:

When the communication session with the 1x base station 2012 has been established, the timing calculator 471 employs the IMSI stored in the storage section 48 to calculate the PGSLOT depicted in expression (7), and stores the result in the storage section 48.

Step ST3:

Following this, the controller 49 permits the RF switching section 21 to connect the EV-DO signal processor 23 to the antenna 10, and starts the EV-DO communication using the EV-DO signal processor 23 and the EV-DO protocol processor 41. Then, a neighboring EV-DO base station 2011 is searched for, and negotiation is performed to establish an EV-DO communication session with the EV-DO base station 2011.

Steps ST4, ST5 and ST6:

The program information controller 46 obtains, from the BCMCS controller 206 via the currently connected EV-DO base station 2011, data for a program table (program information) to receive BCMCS data (step ST4). Then, based on the data in the obtained program table, a request for a desired program that can be currently received is transmitted to the EV-DO base station 2011 (step ST5). Upon receiving this request, BCMCS data are transmitted from the BCMCS content server 207 via the EV-DO base station 2011 to the mobile communication apparatus 100. Then, the BCMCS data are received by the EV-DO signal processor 23 and the EV-DO protocol processor 41, and are accepted by the controller 49. Thereafter, managed by the controller 49, the BCMCS data are transmitted to the stream processor 44 and are reproduced as image data or audio data (step ST6).

Steps ST7 and ST8:

The controller 49 determines whether the reception of BCMCS data is completed. When the reception is completed, the controller 49 is shifted to a predetermined idle state.

Step ST9:

When the reception of BCMCS data is not completed, the timing detector 472 monitors the current time to determine whether it is separated from the starting point for a slot cycle by a distance equivalent to a PGSLOT. When this time has not yet been reached, the controller 49 returns to step ST6 and continues to receive BCMCS data.

Steps ST10, ST11 and ST12:

When the timing detector 472 detects that the time is currently separated from the starting point for the slot cycle by a distance equivalent to PGSLOT the controller 49 permits the RF switching section 21 to connect the 1x signal processor 22 to the antenna 10 (step ST10), monitors a page channel for a predetermined period (e.g., the period for one slot), and receives a page message from the 1x base station 2012 (step ST11). Thereafter, the controller 49 permits the RF switching section 21 to again connect the EV-DO signal processor 23 to the antenna 10 and returns to step ST6 (step ST12).

When at step ST9 the time is currently within the range represented in expression (7), the controller 49 does not perform the above described process and returns to step ST6.

As described above, according to this embodiment, the timing for the transmission of a page message by the 1x base station 2012 to each terminal is limited to a specific period (a period equivalent to that of an R slot) during one slot cycle (64 slots ˜5.12 seconds). The page message reception timing for the mobile communication apparatus 100 is determined based on the PGSLOT that is obtained by expression (7) based on the unique identification information (IMSI). Further, the EV-DO base station 2011 transmits BCMCS data during a period that does not overlap the R slot period. When the reception timing defined based on the PGSLOT in expression (7) is reached while the mobile communication apparatus 100 is receiving BCMCS data, the communication system of the mobile communication apparatus 100 is switched from EV-DO to 1x, and the reception of page messages is started during the R slot period. Thereafter, the communication system of the mobile communication apparatus 100 is switched from 1x to EV-DO, and the reception of BCMCS data is resumed.

Therefore, during the reception of BCMCS data, such as streaming data for which retransmission is not performed, the mobile communication apparatus 100, without failing to receive this data, can receive a page message that is cyclically transmitted by the 1x base station 2012. Therefore, in the state wherein the connection with the 1x base station 2012 is established, BCMCS data transmitted by the EV-DO base station 2011 can be stably received.

One embodiment of the present invention has been described. However, the present invention is not limited to this embodiment, and can be variously modified.

In this embodiment, 1x and EV-DO communication systems are employed for communication with base stations. The present invention is not limited to these systems, however, and an arbitrary system can be employed. Further, for the transmission of streaming data from the base station to the mobile communication terminal, the communication method is not limited to BCMCS, and an arbitrary method can be employed.

For the actual changing of the communication system by the RF switching section 21, a shifting time, such as T_{DO} or T₁ₓ in FIG. 1, is provided. Therefore, it is preferable that the EV-DO or 1x reception operation not be performed during this shifting time. That is, before and after the slot period, the EV-DO base station 2011 may provide an interval that is longer than the shifting time, and may halt the transmission of BCMCS data during this interval. Thus, the failure to receive data can be more appropriately reduced.

Since the transmission of BCMCS data is halted during the period for the R slot, the controller 49 may temporarily halt the reception of data by the EV-DO signal processor 23 during this period. Therefore, power consumption can be reduced.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. A communication system, comprising:
a first communication system for broadcasting a content intermittently; and
a second communication system that is monitored periodically by switching from the first communication system,
wherein in the first communication system, the content is transmitted by being divided into packets, and transmission timings of the packets are shifted.

2. The communication system according to claim 1, wherein the transmission timings of the packets are shifted for a period of time that is equal to or longer than a period for monitoring the second communication system.

3. The communication system according to claim 1, wherein in the first communication system, a size of each of the packets is shortened for a period of time that is equal to or longer than the period for monitoring the second communication system.

4. A base station for broadcasting a content by a first communication system, the base station comprising:
a transmitter which divides the content into packets and transmits each of the packets intermittently; and
a controller which shifts transmission timings of the packets.

5. The base station according to claim 4, wherein the controller shifts the transmission timings of the packets for a period of time that is equal to or longer than a period for monitoring a second communication system being monitored periodically by switching from the first communication system.

6. The base station according to claim 4, wherein the controller shortens a size of each of the packets for a period of time that is equal to or longer than the period for monitoring the second communication system.

7. A communication apparatus comprising;
a first communication section which receives broadcast of a content intermittently;
a second communication section which monitors periodically by switching from the first communication section; and
a controller which performs a control of the switching between the first communication section and the second communication section.

8. The communication apparatus according to claim 7, wherein the controller performs the control so that the switching is not performed when it is estimated that the first communication section is in a communication period.

9. The communication apparatus according to claim 8, wherein the controller estimates that the first communication section is in the communication period based on an intermittent broadcasting cycle of the first communication section and a monitoring period of the second communication section.

10. The communication apparatus according to claim 7, wherein the controller estimates a timing of the switching based on an intermittent broadcasting cycle of the first communication section and a monitoring period of the second communication section.

11. The communication apparatus according to claim 7, wherein the controller estimates a timing of the switching by employing a monitoring timing of the second communication section as a reference.

12. The communication apparatus according to claim 7, wherein the controller permits the first communication section to receive the broadcast of the content and starts to estimate a timing of the switching, based on program information received by the first communication section.

13. The communication apparatus according to claim 7, wherein a monitoring period of the second communication section is longer than a receiving period of the second communication section.

14. A communication method, comprising:
receiving a broadcast content intermittently by a first communication system;
monitoring a second communication system periodically by switching from the first communication system:
estimating a timing of the switching based on an intermittent broadcasting cycle of the first communication system and a monitoring period of the second communication system; and
controlling the switching based on the estimated timing.
